(19) United States
(12) Patent Application Publication
(10) Pub. No.: US 2025/0289718 A1
(43) Pub. Date: Sep. 18, 2025

(54) Self-Assembled Electrically Conductive Biocompatible Embedded CNF Wiring and Method Thereof

(71) Applicant: The United States of America, as Represented by the Secretary of the Navy, Arlington, CA (US)

(72) Inventors: Emil Paskalev Kartalov, Pacific Grove, CA (US); Jeffrey Kyle Catterlin, Salinas, CA (US); Michael Krause, Carmel, CA (US)

(21) Appl. No.: 18/919,033

(22) Filed: Oct. 17, 2024

Related U.S. Application Data
(60) Provisional application No. 63/564,839, filed on Mar. 13, 2024.

(51) Int. Cl. C01B 32/15; B33Y 10/00; B33Y 70/00; B33Y 80/00; H01B 1/24

(52) U.S. Cl. CPC C01B 32/15; H01B 1/24; B33Y 10/00; B33Y 70/00; B33Y 80/00; C01P 2004/16; C01P 2004/61; C01P 2004/62; C01P 2004/64; C01P 2006/22; C01P 2006/40

(57) ABSTRACT

A conductive suspension solution comprising: carbon nanofibers (CNF); and a solvent; the CNF having an electrical conductivity in the range of 10 S/cm and 3000 S/cm, a diameter of 50-200 nanometers, and a length of 50-200 micrometers; the solvent being configured to suspend the CNF and evaporate; and the CNF and the solvent combined to form a heterogeneous suspension solution.

### CROSS-REFERENCE TO RELATED APPLICATIONS

This patent application takes priority from U.S. Provisional Patent Application No. 63/564,839, filed on Mar. 13, 2024, titled Self-Assembled Electrically Conductive Biocompatible Embedded CNF wiring, the contents of which are expressly incorporated herein by this reference as though set forth in their entirety and to which priority is claimed.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to combining conductive and nonconductive material in 3-dimensional (3D) print manufacturing of microfluidics. More specifically, the present disclosure relates to CNF embedded electrical conductors of microfluidics and methods thereof.

### BACKGROUND

Generally, microfluidics is both the science that studies the behavior of fluids through micro-channels and the technology of manufacturing microminiaturized devices containing chambers and tunnels through which fluids flow or are confined.

The 3D printing of microfluidics has a range of impactful applications, such as artificial muscles, actuators, biofuel cells, flexible electronics, and biomedical diagnostic wearables.

Traditional microfluidic devices are limited to 2D arrays due to the fabrication techniques involved, e.g., replication molding. Traditional 2D fabrication produces numerous components, e.g., layers requiring assembly.

3D printing can bring automated fabrication with built-in integration of multiple layers/floors/subassemblies—3D-printed microfluidics—which brings significantly enhanced manufacturing capabilities of 3D printing to all the applications of microfluidics.

3D printing materials can vary widely, with options that include plastic, powders, resins, metal, and carbon fiber.

Combining conductive and nonconductive materials in 3D print manufacturing is difficult because the 3D printing technology for each material varies in process and handling before, during, and after each layer is produced. Problems include low conductivity, moisture sensitivity, nozzles, anisotropic, oxidation, diffusion, and deformation.

Using 3D printing for the related devices solves many problems and offers significant manufacturing advantages, but it also poses a problem with electrical connections within the printed article because conductive/nonconductive hybrid 3D printing remains outside reach.

Therefore, a method of combining conductive and nonconductive materials is needed for the 3D printing of microfluidics.

### SUMMARY

To minimize the limitations in the prior art, and to minimize other limitations that will become apparent upon reading and understanding the present specification, the present disclosure discloses a new and useful self-assembled electrically conductive biocompatible embedded CNF wiring and method thereof.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with combining conductive and nonconductive materials in a 3D printing process is solved by particle deposition of carbon nanofiber (CNF).

Carbon nanofibers (CNF), capable of conducting electrical currents, and solvents may be combined to produce a solution with suspended particles. The solution may be injected or flowed into hard or soft microfluidics, and the solvent may be removed. The viscosity of the solution may be controlled by the concentration of CNF to improve application within a microfluidic. Applying ultrasonic energy to the solution may improve the suspension qualities of the CNF. Once in the microfluidic system, the solvent may be evaporated from the solution, and the CNF may be deposited on the microfluidic surface. CNF deposition may be repeated until a desired conductivity or current handling capability is reached. Additionally, CNF may be electroplated to improve conductivity.

One embodiment of the present disclosure may include a conductive suspension solution comprising: a plurality of carbon nanofibers (CNF); and a solvent; the CNF having an electrical conductivity in the range of 10 S/cm and 3000 S/cm, a diameter of 50-200 nanometers, and a length of 50-200 micrometers; the solvent being configured to suspend the plurality of CNF and evaporate; and CNF and the solvent combined to form a heterogeneous suspension solution. Wherein the CNF may be selected from the group of CNF comprising graphene, buckminsterfullerene, PAN-based carbon fibers, carbon fibers from pitch, carbon fibers from isotropic pitch, carbon fibers from anisotropic mesophase pitch, carbon fibers from rayon, carbon fibers from phenolic resins, and vapor-grown carbon fibers. Wherein the solvent may be a polar solvent selected from the group of polar solvents comprising gum Arabic, cellulose nanocrystal, sodium hypochlorite, sodium bromide, diethyl ether, and ethylene glycol. Wherein the solvent may be an organic solvent selected from the group of solvents consisting of one or more of N—N-dimethylformamide (DMF), tetrahydrofuran (THF), chloroform, or acetone. Wherein the dispersant may be selected from the group of dispersants comprising mechanical stirring, ball milling, ultrasonic treatment, acid functionalization, and adding surfactants.

One embodiment of the present disclosure may include method of creating a conductor in a nonconductive microfluidic comprising: providing a plurality of carbon nanofibers (CNF), wherein the CNF may be electrically conductive; providing a solvent, wherein the solvent may be configured to suspend the CNF and evaporate; combining the CNF and the solvent; creating, by suspending the CNF in the solvent, a conductive suspension solution; providing a microfluidic channel, wherein the microfluidic channel may be configured to receive a conductive suspension solution and remove an evaporated solvent; injecting the conductive suspension solution into the microfluidic channel; separating the solvent from the conductive suspension solution by evaporation of the solvent; and depositing CNF on the surface of the microfluidic channel. Wherein the combining the CNF and the solvent may be by sonication. Wherein evaporation may be by a vacuum or heat. May further including repeating injecting, separating, and depositing until conductivity saturation or an electrical conductivity specification may be reached. May further include electroplating the CNF with metal nanoparticles. Wherein the microfluid channel may be a hard resin. Wherein a microfluid channel structure may be a hard resin with a soft resin forming the microfluid channel.

An alternative method may include 3D printing a microfluidic conductor comprising: printing, by 3-dimensionally printing techniques, a microfluidic structure having microfluidic channels, wherein the microfluidic channel may be configured to receive a conductive suspension solution and remove an evaporated solvent; providing carbon nanofibers (CNF), wherein the CNF may be electrically conductive; providing a solvent, wherein the solvent may be configured to suspend the CNF and evaporate; combining the CNF and the solvent; creating, by suspending the CNF in the solvent, a conductive suspension solution; injecting the conductive suspension solution into the microfluidic channel; separating the solvent from the conductive suspension solution by evaporation of the solvent; and depositing CNF on the surface of the microfluidic channel. Wherein the 3D printing technique may be selected from one or more of the 3D printing techniques consisting of: inkjet, fused deposition modeling (FDM), stereolithography (SLA), and selective laser sintering (SLS). Wherein the combining the plurality of CNF and the solvent may be by sonication. Wherein separating the solvent from the conductive suspension solution comprises evaporation. Wherein evaporation may be by a vacuum or heat. May further include repeating injecting, separating, and depositing until conductivity saturation or an electrical conductivity specification may be reached. Wherein the microfluid channel may be a hard resin. Wherein a microfluid channel structure may be a hard resin with a soft resin forming the microfluid channel. It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a microfluidic chip.

FIG. 2 are illustrations of successive carbon nanofiber deposition injections.

FIG. 3 are graphs showing the electrical resistance of the CNF deposition in a channel based on microfluidic channel width using a hard resin.

FIG. 4 are graphs showing the electrical resistance of the CNF deposition in a channel based on microfluidic channel width using a soft resin.

FIG. 5 is a block flow diagram showing one embodiment of a process for creating a conductor in a nonconductive microfluidic.

FIG. 6 is a block flow diagram showing one embodiment of a process for 3-dimensionally printing a microfluidic conductor.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “chips” or “microfluidic chips” refer to small-scale devices used across diverse scientific studies and industrial fields.

As used herein, the term “saturation” or “conductivity saturation” refers to the condition that occurs when additional conductive material no longer changes a conductivity measurement and is constant or when a channel is clogged and can no longer accept additional conductive material.

As used herein, the term “sacrificial material” refers to material used as a temporary support or template that is later removed to when a component or structure is finished.

As used herein, the term “sonicating” refers to the process of applying sound energy to agitate particles or discontinuous fibers in a liquid.

As used herein, the term “suspension stability” refers to the ability of a suspension to resist aggregation or settling.

Microfluidics may be manufactured by laser ablation, laser micromachining, 3-dimensionally (3D) printing, casting, micro-embossing, selective laser etching, bonding, bulk micromachining, and photolithography. Microfluidics may be manufactured as microfluidic chips. Microfluidic chips may be patterns of microchannels that may form networks of microchannels incorporated into the microfluidic chip. The microchannels may then be linked to a macro-environment by several holes of different dimensions, creating volumes through the chip. The microchannel network allows fluids to be injected in and out of the microfluidic chip.

Microfluidic chips may be made from a variety of materials, including inorganic materials like glass, silicon, and ceramic, polymers like COC, polymethyl methacrylate (PMMA), and polydimethylsiloxane (PDMS).

3D printing microfluidics may include: 1) multi-material extrusion, where multiple materials are extruded through the printer's nozzles to build the device layer by layer; 2) computed axial lithography (CAL), uses a series of images from a digital light processing (DLP) printer to expose a polymer resin; 3) fused deposition modeling, where heated plastic may be laid down in slices and built up in the Z axis; and 4) inkjet printing, were powder particles are spread over a platform, and hydrogel droplets or low-viscosity photocurable resin are used as printing materials.

3D printing may be a rapid and cost-effective technique in manufacturing microfluidic devices. Microfluidic channels may efficiently be manufactured using photopolymer resins and ultraviolet (UV) light to cure the resins.

Microfluidics may be manufactured using hard or soft resins. Microfluidic devices may be used in many applications, including but not limited to biomedical devices, chemical processors, micro actuators, wearable devices, micro and nanobiology, micro and nano analysis, micro and nanoelectronics, and fast and in situ detection of bacteria.

Biocompatible electrically conductive connections and wiring may be manufactured within the 3D printed microfluidics by particle deposition of carbon nanofibers (CNF) but should not be limited to only CNF.

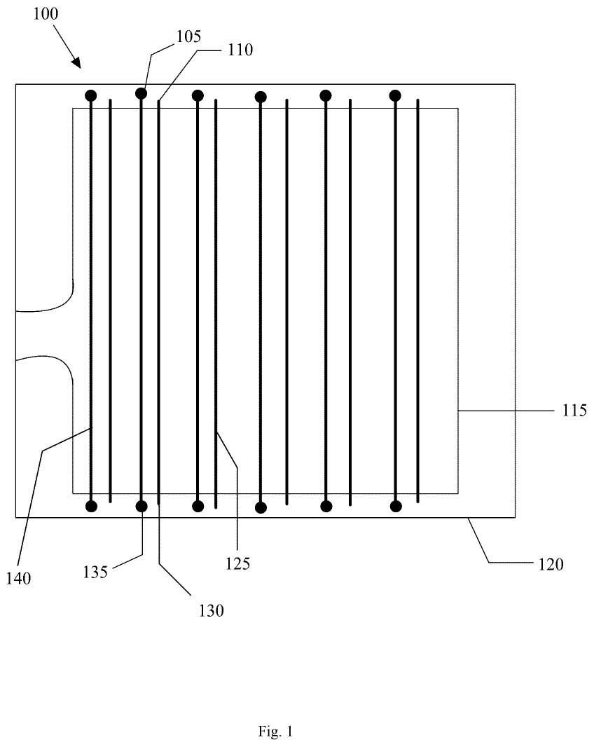

FIG. 1 is an illustration of one embodiment of a microfluidic chip. Microfluidic chip 100 may include inlets/outlets 105 and 135, focus region 115, frame 120, channels 140, calibration lane 125, and calibration ends 110 and 130.

Inlets/outlets 105 and 135 may preferably be formed using 3D printing techniques but may also be formed using typical microchannel manufacturing techniques. Inlets/outlets 105 and 135 and channel 140 may have a length/and a cross-section A. Fluid may flow from 105 to 135, or from 135 to 105. Channels may also be formed using sacrificial material such as but not limited to SUP706. SUP706 may be removed in post-processing to leave open or unobstructed channel 140 or volumes (not shown).

Focus region 115 may be an area of microfluidic chip 100 in which fluid, particles, gases, or other objects may be acted upon as they flow through channel 140 or volumes (not shown). Focus region 115 may include but should not be limited to sensors, reactors, reservoirs, artificial muscles, electrical loads, or other interfaces (not shown). Focus region 115 may have sensors, actuators, and various other devices that require electrical energy to function or act upon the fluid, particles, gases, or other objects within the focus region 115.

Frame 120 may be a supporting structure of microfluidic chip 100 but may not be required. Frame 120 may also accept and provide mechanical connections for Inlets/outlets 105 and 135. Frame 120 may also provide mechanical connections for sensors and other interfaces (not shown).

Channel 140 may include an internal surface (not shown), which may provide a surface area for particle deposition. Particles may be deposited on the internal surface of channel 140 or other volumes (not shown) during the evacuation of sacrificial material or following the clearing process of channels 140. Particles may be deposited by injecting or passing gases or fluids having suspended particles into channels 140.

Calibration lane 125, and calibration ends 110 and 130 may not be cleared and used for calibration.

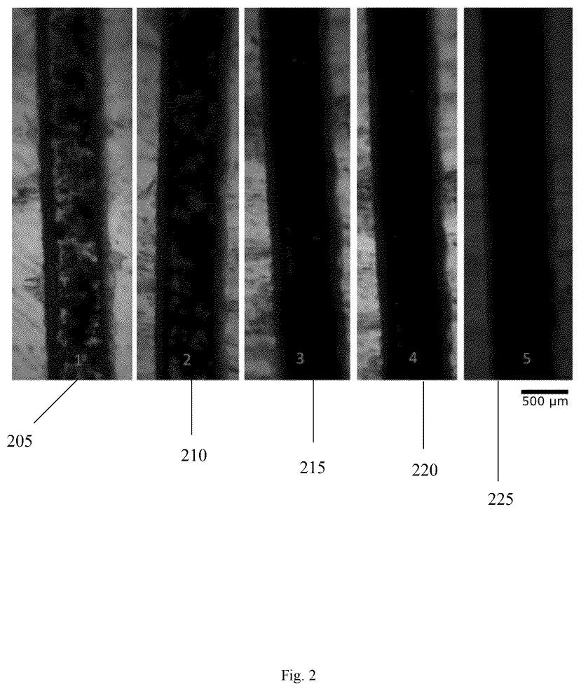

FIG. 2 are illustrations of successive carbon nanofiber deposition injections. FIG. 2 shows five successive depositions of carbon nanofiber (CNF) particles. First 205, second 210, third 215, fourth 220, and fifth 225 depositions are the results of evaporative solvent removal from a carbon nanofiber (CNF) solution. Although the deposition of CNF is illustrated in FIG. 2, the process may also be illustrative of other particles that may be deposited on the surface of channel 140. As shown in FIG. 2, each successive deposition may cover more of the channel 140 surface. Although (not shown) the depth of the deposition may also be increased which may improve conductivity and current handling capacity.

Resistivity along the surface of channel 140 may decrease with successive depositions of particles along the surface of channel 140. If a CNF deposition completely blocks channel 140, resistivity may no longer change. The following mathematical equation may describe electrical resistivity.

$$ρ = R \frac{A}{l}$$

l=length of the channel
A=cross-section area of the channel
R=Electrical resistance

Electrical conductivity is the reciprocal of electrical resistivity. It represents a material's ability to conduct electric current. The SI unit of electrical conductivity is Siemens per meter (S/m). Electrical resistance and conductance are corresponding extensive properties that give the opposition of a specific object to electric current.

CNF-deposited particles may range in diameter from 50-200 nanometers and a length of 50-200 micrometers.

CNF particle size and shape may affect a solvent's suspension stability viscosity and ultimately control the rate at which individual injections may deposit CNF to the surface of channel 140. An increase in the amount of CNF particles per volume may increase the viscosity of a solution.

The number of successive deposition occurrences may control the electrical conductivity of the deposited CNF embedded conductor.

In one embodiment, CNF particles may be suspended within a solvent having a suspension stability of 10-100% for 1 hour. Polar solvents such as but not limited to gum Arabic, cellulose nanocrystal, diethyl ether, ethylene glycol, sodium hypochlorite, and sodium bromide may suspend CNF particles. Additionally, Organic solvents such as but not limited to ethanol, isopropyl alcohol, N-methyl-2-pyrrolidone, N—N-dimethylformamide (DMF), propylene carbonate, tetrahydrofuran (THF), chloroform, or acetone may suspend CNF particles.

In an alternative embodiment, CNF particles may be suspended in a gas to form an aerosol having a suspension stability of 10-100% for 1 hour. Aerosols may carry carbon nanofibers (CNFs) in a variety of ways, including aerosol jet printing, electro-aerodynamic deposition, and aerosol spray method.

In an alternative embodiment, electrical conductivity may be increased by adding metal nanoparticles suspended in a carrying solution. The metal nanoparticles may be suspended in an ionic fluid emulsion with low viscosity. A low viscosity may improve fluid injection into channel 140. Additionally, metal nanoparticles may also be attached to CNF by electroplating. Electroplating CNF may improve conductivity and reduce saturation in the deposition of CNF. Electroplating CNF may include the deposition of suspended metal ions in an electrolyte solution, which may be fed fluidically into the CNF matrix in channel 140, and then the electrolyte and the CNF matrix may be electrically biased to electroplate the metal ions onto the CNFs throughout the channel 140. Electroplating may include self-assembled by intentionally local depletion of metal ions from the electrolyte using motionless fluid and limitations of diffusion speed along the microchannel. This process may lead to a deposition of metal onto the deposited CNF matrix of channel 140. Additionally, electroplating CNF may include dissolved ions in a liquid fed into the channels. Metal nanoparticles may include but should not be limited to copper, iron, silver, gold, nickel, chromium, and/or titanium.

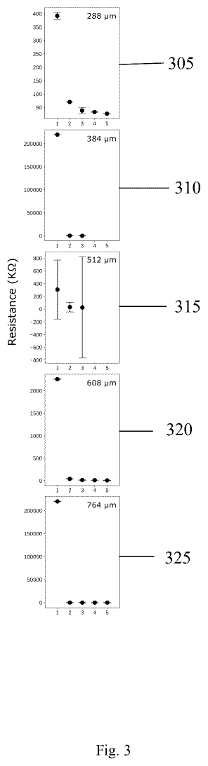

FIG. 3 are graphs showing the electrical resistance of the CNF deposition in a channel based on microfluidic channel width using a hard resin. As shown in FIG. 3, 100 measurements were taken using a 99% isopropanol solvent having a concentration of 0.3 to 0.6 mg/ml of CNF for each channel width and deposition number. An increase in CNF concentration may decrease the number of depositions required to achieve the desired result.

The first deposition of channel width 305, 288 μm produced a resistance of approximately 390 KΩ. Subsequent deposition may decrease resistance. The second deposition of channel width 305 shows an improved resistance to approximately 75 KΩ. The third deposition of channel width 305 further improved the measured resistance to 45 KΩ. The fourth and fifth depositions show that the rate of improved resistance approaches a saturation point, and at channel width 305, a saturation point may be near 40 KΩ with little to no variance in sampled measurements.

The first deposition of channel width 310, 384 μm produced a resistance above 200,000 KΩ. Subsequent deposition may decrease resistance. The second and third depositions show that the rate of improved resistance approaches a saturation point, and at channel width 310, a saturation point may be near zero ohm with little to no variance in sampled measurements.

The first deposition of channel width 315, 512 μm produced a resistance of approximately 300 KΩ. Subsequent deposition may decrease resistance. The second and third depositions show that the rate of improved resistance approaches a saturation point, and at channel width 315, a saturation point may be near zero ohm with a high level of variance in sampled measurements.

The first deposition of channel width 320, 608 μm produced a resistance above 2,000 KΩ. Subsequent deposition may decrease resistance. The second deposition of channel width 320 shows an improved resistance to near zero ohm. The third, fourth, and fifth depositions show that the rate of improved resistance approaches a saturation point, and at channel width 320, a saturation point may be near zero ohm with little to no variance in sampled measurements.

The first deposition of channel width 325, 764 μm produced a resistance above 2,000 KΩ. Subsequent deposition may decrease resistance. The second deposition of channel width 325 shows an improved resistance to near zero ohm. The second, third, fourth, and fifth depositions show that the rate of improved resistance approaches a saturation point, and at channel width 320, a saturation point may be near zero ohm with little to no variance in sampled measurements.

The table below are the mean conductivities of each channel width with the representative standard deviation.

| Channel width and height (μm) | Conductivity (S/m) |
|---|---|
| 608 | 31.98 ± 1.81 |
| 764 | 27.30 ± 0.36 |
| 800 | 19.19 ± 0.78 |
| 896 | 14.58 ± 2.00 |
| 996 | 9.27 ± 0.20 |

Hard resin, such as but not limited to VeroClear-RGD810, may be used to produce microfluidic chips.

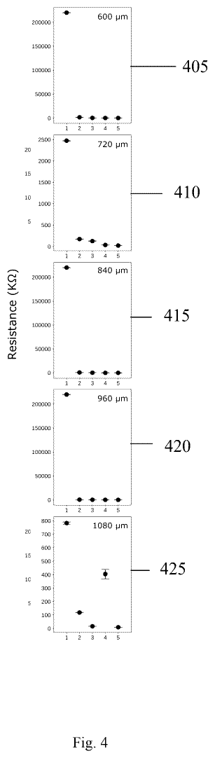

FIG. 4 are graphs showing the electrical resistance of the CNF deposition in a channel based on microfluidic channel width using a soft resin. As shown in FIG. 4, 100 measurements were taken using a 99% isopropanol solvent having a concentration of 0.3 to 0.6 mg/ml of CNF for each channel width and deposition number. An increase in CNF concentration may decrease the number of depositions required to achieve the desired result.

The first deposition of channel width 405, 600 μm produced a resistance above 200,000 KΩ. Subsequent deposition may decrease resistance. The second deposition of channel width 405 shows an improved resistance to approximately zero ohm. The second, third, fourth, and fifth depositions show that the rate of improved resistance approaches a saturation point, and at channel width 405, a saturation point may be near zero ohm with little to no variance in sampled measurements.

The first deposition of channel width 410, 720 μm produced a resistance of approximately 2,500 KS. Subsequent deposition may decrease resistance. The second and third deposition show that the rate of improved resistance approaches a saturation point near 200 KΩ, and at channel width 410, a saturation point may be near zero ohm with a fourth and fifth deposition with little to no variance in sampled measurements.

The first deposition of channel width 415, 840 μm produced a resistance above 200,000 KΩ. Subsequent deposition may decrease resistance. The second and third depositions show that the rate of improved resistance approaches a saturation point, and at channel width 415, a saturation point may be near zero ohm with a high level of variance in sampled measurements.

The first deposition of channel width 420, 960 μm produced a resistance above 200,000 KΩ. Subsequent deposition may decrease resistance. The second, third, fourth, and fifth depositions show that the rate of improved resistance approaches a saturation point, and at channel width 420, a saturation point may be near zero ohm with little to no variance in sampled measurements.

The first deposition of channel width 425, 1,080 μm produced a resistance above 700 KΩ. Subsequent deposition may decrease resistance. The second deposition of channel width 425 shows an improved resistance to near 150 KΩ. The third and fifth depositions show that the rate of improved resistance approaches a saturation point, and at channel width 420, a saturation point may be near zero ohm with little to no variance in sampled measurements.

The table below are the mean conductivities of each channel width with their standard deviations.

| Channel width and height (μm) | Conductivity (S/m) |
|---|---|
| 600 | 7.54 ± 7.56 |
| 720 | 13.00 ± 0.27 |
| 840 | 4.39 ± 0.28 |
| 960 | 4.06 ± 0.001 |
| 1,080 | 5.47 ± 0.02 |

Soft resin, such as but not limited to Agilus30 Clear FLX985, may improve elasticity and, combined with conductive channel 140, may be used for but not limited to peristalsis functions, artificial muscles, wave creators, and speakers.

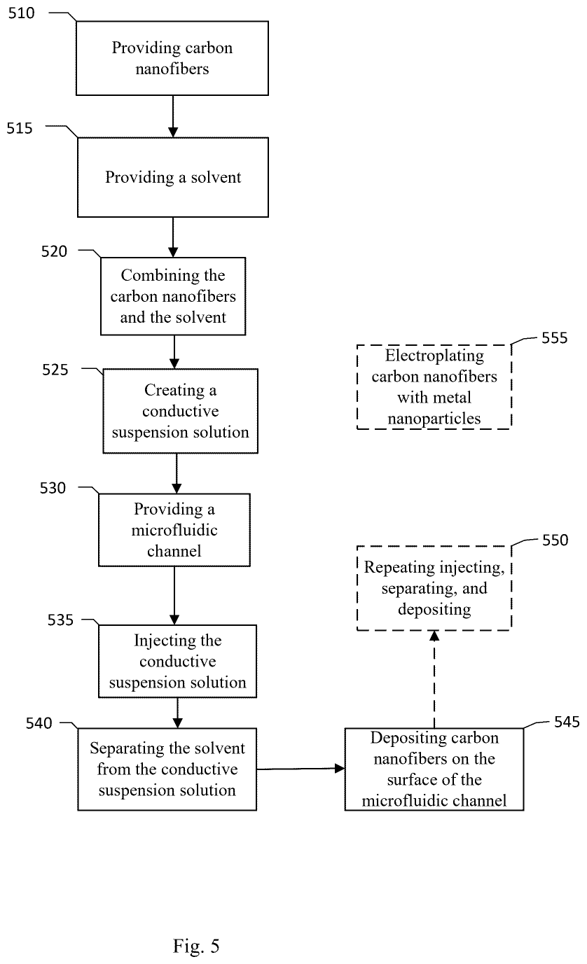

FIG. 5 is a block flow diagram showing one embodiment of a process for creating a conductor in a nonconductive microfluidic. In one embodiment, the method of creating a conductor in a nonconductive microfluidic may comprise providing a plurality of carbon nanofibers (CNF) 510, wherein the plurality of CNF may be electrically conductive; providing a solvent 515, wherein the solvent has suspension stability of 10-100% for 1 hour, and a concentration in the range of 0.1 to 1.0 mg/ml of CNF for each channel width and deposition number; combining the CNF and the solvent 520; creating 525, by suspending the plurality of CNF in the solvent, a conductive suspension solution; providing a microfluidic channel 530, the microfluidic channel preferably configured to receive a conductive suspension solution and allow for evaporation of a solvent; injecting the conductive suspension solution 535 into the microfluidic channel; separating the solvent from the conductive suspension solution 540 by evaporation of the solvent; depositing CNF 545 on the surface of the microfluidic channel;

Combining the CNF and the solvent may be completed by sonication.

The evaporation may be completed by a vacuum or heat.

In an alternative embodiment, the method may further include repeating injecting, separating, and depositing until conductivity saturation or an electrical conductivity specification is reached.

In an alternative embodiment, the method may further include electroplating the CNF with metal nanoparticles. In one embodiment the microfluid channel structure may be a hard resin with a soft resin forming the microfluid channel.

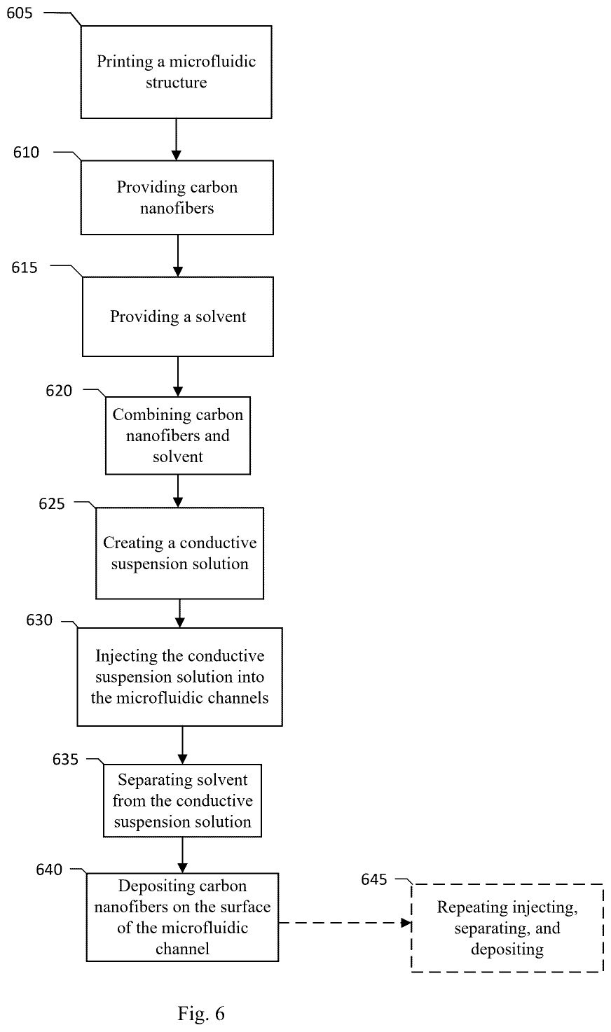

FIG. 6 is a block flow diagram showing one embodiment of a process for 3-dimensionally printing a microfluidic conductor. In one embodiment, the method of a method of 3D printing a microfluidic conductor may comprise printing 605, by 3-dimensionally printing techniques, a microfluidic structure having one or more microfluidic channels, wherein the one or more microfluidic channel may be configured to receive a conductive suspension solution and remove an evaporated solvent; providing a plurality of carbon nanofibers (CNF) 610; providing a solvent 615, wherein the solvent has a suspension stability of 10-100% for 1 hour; combining the plurality of CNF and the solvent 620; creating 625, by suspending the plurality of CNF in the solvent, a conductive suspension solution; injecting the conductive suspension solution into the microfluidic channel 630; separating the solvent from the conductive suspension solution by evaporation of the solvent 635; depositing CNF on the surface of the microfluidic channel 640;

A 3D printing technique may be but should not be limited to inkjet, fused deposition modeling (FDM), stereolithography (SLA), and selective laser sintering (SLS).

Combining the CNF and the solvent may be completed by sonication.

Separating the solvent from the conductive suspension solution may include but should not be limited to evaporation. Evaporation may be completed by but should not be limited to a vacuum or heat.

In an alternative embodiment, the method may further include repeating injecting, separating, and depositing until conductivity saturation or an electrical conductivity specification is reached.

In an alternative embodiment, the method may further include electroplating the CNF with metal nanoparticles. In one embodiment the microfluid channel structure may be a hard resin with a soft resin forming the microfluid channel.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A conductive suspension solution comprising:
a plurality of carbon nanofibers (CNF); and
a solvent;
the plurality of CNF having an electrical conductivity in the range of 10 S/cm and 3000 S/cm, a diameter of 50-200 nanometers, and a length of 50-200 micrometers;
the solvent being configured to suspend the plurality of CNF and evaporate; and
the plurality of CNF and the solvent combined to form a heterogeneous suspension solution.

2. The conductive suspension solution of claim 1, wherein the plurality of CNF is selected from the group of CNF consisting of one or more of: graphene, buckminsterfullerene, PAN-based carbon fibers, carbon fibers from pitch, carbon fibers from isotropic pitch, carbon fibers from anisotropic mesophase pitch, carbon fibers from rayon, carbon fibers from phenolic resins, and vapor-grown carbon fibers.

3. The conductive suspension solution of claim 1, wherein the solvent is a polar solvent selected from the group of polar solvents consisting of one or more of: gum Arabic, cellulose nanocrystal, sodium hypochlorite, sodium bromide, diethyl ether, and ethylene glycol.

4. The conductive suspension solution of claim 1, wherein the solvent is an organic solvent selected from the group of solvents consisting of one or more of N—N-dimethylformamide (DMF), tetrahydrofuran (THF), chloroform, or acetone.

5. The conductive suspension solution of claim 1, further comprising a dispersant, wherein the dispersant is selected from the group of dispersants consisting of one or more of: mechanical stirring, ball milling, ultrasonic treatment, acid functionalization, and adding surfactants.

6. A method of creating a conductor in a nonconductive microfluidic comprising:
providing a plurality of carbon nanofibers (CNF), wherein the plurality of CNF is electrically conductive;
providing a solvent, wherein the solvent is configured to suspend the plurality of CNF and evaporate;
combining the plurality of CNF and the solvent;
creating, by suspending the plurality of CNF in the solvent, a conductive suspension solution;
providing a microfluidic channel, wherein the microfluidic channel is configured to receive a conductive suspension solution and remove an evaporated solvent;
injecting the conductive suspension solution into the microfluidic channel;
separating the solvent from the conductive suspension solution by evaporation of the solvent; and
depositing CNF on the surface of the microfluidic channel.

7. The method of claim 6, wherein the combining the plurality of CNF and the solvent is by sonication.

8. The method of claim 6, wherein evaporation is by a vacuum or heat.

9. The method of claim 6 further comprising repeating injecting, separating, and depositing until conductivity saturation or an electrical conductivity specification is reached.

10. The method of claim 6, further comprising electroplating the CNF with metal nanoparticles.

11. The method of claim 6, wherein the microfluid channel is a hard resin.

12. The method of claim 6, wherein a microfluid channel structure is a hard resin with a soft resin forming the microfluid channel.

13. A method of 3D printing a microfluidic conductor comprising:
printing, by 3-dimensionally printing techniques, a microfluidic structure having one or more microfluidic channels, wherein the one or more microfluidic channel is configured to receive a conductive suspension solution and remove an evaporated solvent;
providing a plurality of carbon nanofibers (CNF), wherein the plurality of CNF is electrically conductive;
providing a solvent, wherein the solvent is configured to suspend the plurality of CNF and evaporate;
combining the plurality of CNF and the solvent;
creating, by suspending the plurality of CNF in the solvent, a conductive suspension solution;
injecting the conductive suspension solution into the microfluidic channel;
separating the solvent from the conductive suspension solution by evaporation of the solvent; and
depositing CNF on the surface of the microfluidic channel.

14. The method of claim 13, wherein the 3D printing technique is selected from one or more of the 3D printing techniques consisting of: inkjet, fused deposition modeling (FDM), stereolithography (SLA), and selective laser sintering (SLS).

15. The method of claim 13, wherein the combining the plurality of CNF and the solvent is by sonication.

16. The method of claim 13 wherein separating the solvent from the conductive suspension solution comprises evaporation.

17. The method of claim 13, wherein evaporation is by a vacuum or heat.

18. The method of claim 13, further comprising repeating injecting, separating, and depositing until conductivity saturation or an electrical conductivity specification is reached.

19. The method of claim 13, wherein the microfluid channel is a hard resin.

20. The method of claim 13, wherein a microfluid channel structure is a hard resin with a soft resin forming the microfluid channel.
